(19) United States
(12) Patent Application Publication
(10) Pub. No.: US 2023/0313944 A1
(43) Pub. Date: Oct. 5, 2023

(54) APPARATUS, SYSTEM, AND METHOD FOR TEMPORARILY HOLDING SMALL OBJECTS FOR ADJUSTMENT OR MANIPULATION

(71) Applicant: Jacob Chandler Odom, Dallas, TX (US)

(72) Inventor: Jacob Chandler Odom, Dallas, TX (US)

(21) Appl. No.: 18/130,786

(22) Filed: Apr. 4, 2023

Related U.S. Application Data
(60) Provisional application No. 63/327,024, filed on Apr. 4, 2022.

(51) Int. Cl. F16M 13/04; A45F 5/00

(52) U.S. Cl. CPC F16M 13/04; A45F 5/00; A45F 2200/0575

(57) ABSTRACT

A device for securing a workpiece for manipulation where the device contains a first member section, a second member section removably attached to the first member section and, at least one flexible extension arm removably and adjustably attached to at least the first member section, wherein the at least one flexible extension arm comprises a work tool removably attached to a distal end of the at least one flexible extension arm.

### BACKGROUND OF THE INVENTION

### Field of the Invention

This invention relates to a system, apparatus, and process for securing and holding a small object in a relative position to a user for adaption, adjustment, manipulation, modification, or attachment of an item or items. More specifically, the present invention provides for an apparatus to hold and fixate a workpiece in a generally stable and relative position to the user for installation, adjustment, manipulation or securement of elements, components or the like such as, but not limited to, strings, lines, beads, and hooks thereto.

### Description of Related Art

Preparation of fishing tackle, fishing lures, and/or fishing flies prior to the start of a fishing trip is something all fishermen go through. Tying flies, assembling lures, segregating hooks of various sizes, collecting spools of fishing line of various weights, etc. is conventional tasks that the fisherman undertakes. It is time-consuming, but the time spent up front is not a burden to the fishermen because it is not time taken away from fishing.

However, the measure of difficulty and burden in easily and effortlessly installing and connecting a fishing line while one is in chest deep water, in rocks becomes substantially magnified. This is especially true when the fisherman is having to hold the line to be tied to the new lure, hold the lure, hold the fly-fishing pole etc. while experiencing the environment he is in during any conditions or environment is not an easy chore. Indeed, tying the right kind of knot to attach the line to a particular piece of fishing tackle is something that is not easy when sitting in the comfort of one's home, much more when in the rushing water with your hands full. This is a particular problem for anyone including people with arthritic fingers.

What is needed in the field is a quick and simple apparatus to assist a fisherman with holding a fishing tackle for line installation or other need, where the apparatus is securely mounted and secured to the fisherman's body or clothing to prevent loss or shifting of the apparatus while in use. Similarly, what is also needed in the field is a simple apparatus that can be removably secured to a user's body or clothing to assist users such as crafters, hobbyists or anyone similarly situated that has a need to secure and hold a workpiece while further manipulating or adapting the workpiece in any way.

Various refinements of the features noted above may exist in relation to various aspects of the present embodiments. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. Again, the brief summary presented above is intended only to familiarize the reader with certain aspects and contexts of some embodiments without limitation to the claimed subject matter.

### BRIEF SUMMARY OF THE INVENTION

This summary is provided to introduce a selection of concepts that are further described below in the Detailed Description. This summary is not intended to identify key or essential features of the claimed subject matter, nor is it to be used as an aid in limiting the scope of the claimed subject matter.

Embodiments of the present invention generally relate to a device designed, constructed, and used according to the present invention designed to allow a user, such as a person, in any field (e.g., medical, seamstress, crafter, fisherman, painter, hobbyist), to secure the device to their body or clothing wherein such device then allows for the securement of a workpiece (e.g., a needle, a fishing lure, a fishing fly, a piece of jewelry etc.) to be secured such that the user's hands are freed and not required to be in constant contact with the device or the body for string, thread or line installation, or any change or manipulation to the workpiece.

Objects of the invention not understood from the above, will be fully understood upon the review of the drawings and the description of the preferred embodiments which follow. Various refinements of the features noted above may exist in relation to various aspects of the present embodiments. Further features may also be incorporated in these various aspects as well. These refinements and additional features may exist individually or in any combination. For instance, various features discussed below in relation to one or more of the illustrated embodiments may be incorporated into any aspect of the present disclosure alone or in any combination. Again, the brief summary presented above is intended only to familiarize the reader with certain aspects and contexts of some embodiments without limitation to the claimed subject matter.

### BRIEF DESCRIPTION OF THE DRAWINGS

A more complete understanding of embodiments of the present invention may be obtained by reference to the following Detailed Description when taken in conjunction with the accompanying Drawings wherein:

FIG. 1 illustrates an elevation view of a rigid device in an extended position with flexible extension arms with work tools attached used for holding and securing a workpiece for adjustment, modification, attachment, manipulation, or otherwise according to one embodiment of the present disclosure.

FIG. 2 illustrates an elevation view of a semi-rigid device in an extended position with flexible extension arms with work tools attached used for holding and securing a workpiece for adjustment, modification, attachment, manipulation, or otherwise according to one embodiment of the present disclosure.

FIG. 3 illustrates a front view of a fisherman wearing the rigid device of FIG. 1 being securely attached to her body in an extended position with flexible extension arms with work tools attached used for holding and securing a workpiece for adjustment, modification, attachment, manipulation, or otherwise according to one embodiment of the present disclosure.

### DETAILED DESCRIPTION OF THE INVENTION

In the following description, numerous specific details are set forth to provide a thorough understanding of the present invention. However, it will be apparent to those skilled in the art that the present disclosure may be practiced without such specific details. It is to be understood that both the foregoing general summary description and the following detailed description are illustrative and explanatory, and are not restrictive of the subject matter, as claimed. Specifically, the disclosure and invention is not limited to use in the field of fishing but can be used in any hobbyist field of use or professional setting where the need exists as set forth in this disclosure. The invention and its component configuration can be utilized in any craft, sport, or other venture where free hand use and stability of an item is desired.

It is to be further understood that the following disclosure also provides many different embodiments, or examples, for implementing different features of various illustrative embodiments. Specific examples of components and arrangements are described below to simplify the disclosure. These are, of course, merely examples and are not intended to be limiting. For example, a figure may illustrate an exemplary embodiment with multiple features or combinations of features that are not required in one or more other embodiments and thus a figure may disclose one or more embodiments that have fewer features or a different combination of features than the illustrated embodiment. Embodiments may include some but not all the features illustrated in a figure and some embodiments may combine features illustrated in one figure with features illustrated in another figure. Therefore, combinations of features disclosed in the following detailed description may not be necessary to practice the teachings in the broadest sense and are instead merely to describe particularly representative examples. In addition, the disclosure may repeat reference numerals and/or letters in the various examples. This repetition is for the purpose of simplicity and clarity and does not itself dictate a relationship between the various embodiments and/or configurations discussed.

In this application, the use of the singular includes the plural, the word “a” or “an” means “at least one”, and the use of “or” means “and/or”, unless specifically stated otherwise. Furthermore, the use of the term “including”, as well as other forms, such as “includes” and “included”, is not limiting. Also, terms such as “element” or “component” encompass both elements or components comprising one unit and elements or components that comprise more than one unit unless specifically stated otherwise. In addition, the use of terms such as “above,” “below,” “upper,” “lower,” or other like terms to describe a spatial relationship between various components or to describe the spatial orientation of aspects of such components should be understood to describe a relative relationship between the components or a spatial orientation of aspects of such components, respectively, as the device described herein may be oriented in any desired direction.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms such as “inboard,” “outboard,” “above,” “below,” “upper,” “lower,” or other like terms to describe a spatial relationship between various components or to describe the spatial orientation of aspects of such components should be understood to describe a relative relationship between the components or a spatial orientation of aspects of such components, respectively, as the device described herein may be oriented in any desired direction.

As used herein, the terms “connect,” “connection,” “connected,” “in connection with,” and “connecting” may be used to mean in direct connection with or in connection with via one or more elements. Similarly, the terms “couple,” “coupling,” and “coupled” may be used to mean directly coupled or coupled via one or more elements. Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include such elements or features.

The term “substantially,” “approximately,” and “about” is defined as largely but not necessarily wholly what is specified (and includes what is specified; e.g., substantially 90 degrees includes 90 degrees and substantially parallel includes parallel), as understood by a person of ordinary skill in the art. The extent to which the description may vary will depend on how great a change can be instituted and still have a person of ordinary skill in the art recognized the modified feature as still having the required characteristics and capabilities of the unmodified feature. In general, but subject to the preceding, a numerical value herein that is modified by a word of approximation such as “substantially,” “approximately,” and “about” may vary from the stated value, for example, by 0.1, 0.5, 1, 2, 3, 4, 5, 10, or 15 percent.

The section headings used herein are for organizational purposes and are not to be construed as limiting the subject matter described. If any documents, or portions of documents, are cited in this application, including, but not limited to, patents, patent applications, articles, books, and treatises, such documents are hereby expressly incorporated herein by reference in their entirety for any purpose. In the event that one or more of such incorporated documents etc. and similar materials (if any) defines a term in a manner that contradicts the definition of that term in this application, this application controls.

During the discussion of the structural features of this invention, all references to fishing tackle, pieces of fishing apparatus, jewelry or other hobby areas and the like should be considered in their broadest aspect. The terms are used interchangeably to refer to fishing lures, sinkers, floats and such other pieces of conventional fishing equipment as may be found in sporting goods stores and fishing tackle boxes of fishermen. Similarly, the terms are also used interchangeably to refer to any hobbyist's items that are to be held and manipulated such as, for example only, diamonds, jewelry pieces, ornaments, decorative objects, sewing needles, miniature ornamental items etc. without limitation.

Further, throughout the application, reference will be made to a “free end” of a fishing line. This term is used for descriptive purposes only and should not be construed as meaning that the fishing line terminates. For example, references to the “free end” of the fishing line are intended to refer to that portion of the fishing line remote from the reel of a fishing pole with a fishing lure, float, etc. tied to the line intermediate the “free end”. For purposes of this invention and the language used herein, the “free end” could extend two or three hundred feet beyond and away from the fishing reel.

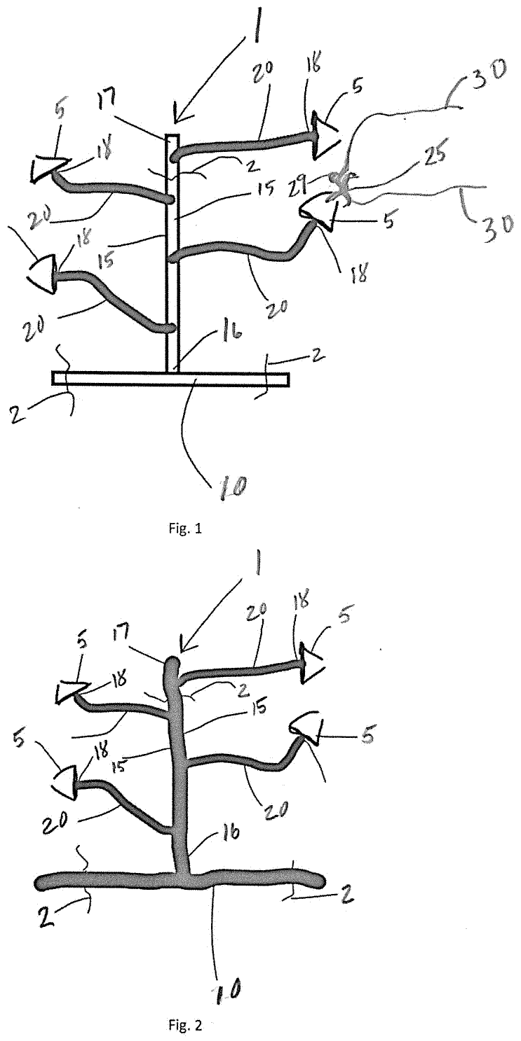

Referring to the drawings, in FIGS. 1-3 are depicted embodiments of the present invention that relate to a device configured structurally to permit a user, such as a person, in any field (e.g., medical, seamstress, crafter, fisherman, painter, hobbyist, jeweler etc.), to removably secure a device 1 to the person's body or clothing, wherein the secured device 1 thereafter provides for positional securement of a workpiece 25 (e.g., a needle, a fishing lure, a fishing fly, a piece of jewelry etc.) by way of a work tool 5 removeably attached to at least one maneuverable extension arm 20. This permits the user's hands to be free and not required to be in constant contact with the workpiece 25 for installation of string, thread, or fishing line 30, or any desired change or manipulation to a workpiece 25 (for example only, to a fishing fly or lure), as shown in FIG. 1.

In one instance, for example only, in the fishing sport field, the speed with which a user can attach a fishing line 30 to a workpiece 25 such as fishing lure or fishing fly 25 often has a direct impact upon the number of fish that can be caught within a given period. It is understood that one skilled in the art that the present invention is not limited to any particular field of use and can be utilized as desired to hold the workpiece 25, hands free, for insertion of string, fishing line 30 (as shown in FIG. 4) or any other object or material to the workpiece 25.

In FIGS. 1-3 the device 1 the present invention comprises a first member section 15, a second member section 10 removably and adjustably connected to the first member section 15, at least one extension arm 20 removably and adjustably connected to the first member section 15 and/or the second member section 10. The device 1 also having at least one removably attached work tool 5 disposed on a distal end 18 of the at least one flexible extension arm 20. The removably attached work tool 5 used may comprise a clamp, a mirror, scissors, knife, magnifying glass, a miniature light, or any other work tool 5 desired to be used with the device 1 for holding the work piece 25 such as shown in exemplary fashion in FIG. 1 as that of a fishing fly. One skilled in the art will readily recognize that the work tool 5 and workpiece 25 is not limited only to the aforementioned listed items but can be chose from numerous items that can assist the user in his desired sport, hobby or other task at hand.

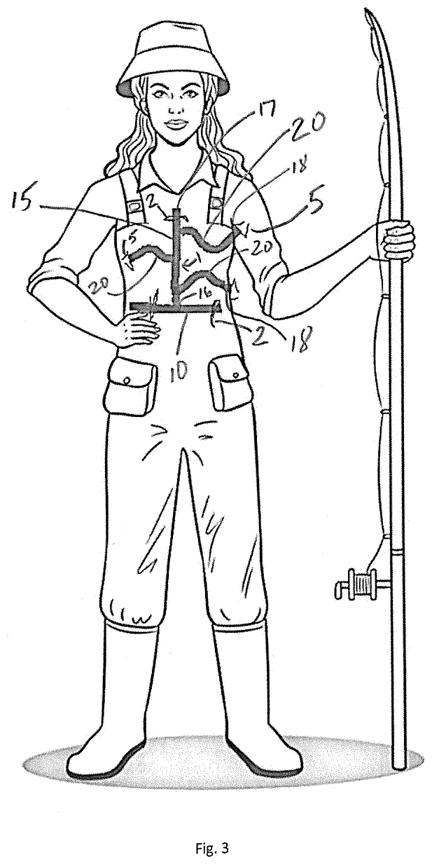

The invention further provides for either a rigid (as shown in FIG. 1), a semi-rigid flexible (as shown in FIG. 2), or a combination of both rigid and semi-rigid flexible first member sections 15 and second member sections 10, wherein the first member section 15 and/or the second member section 10 comprises at least one removably attached flexible extension arm 20 with a removable attached work tool 5 disposed on the flexible extension arm 20. The removably attached work tool 5 as shown in FIGS. 1-3 is a clamp that is used to secure and hold the workpiece 25 (e.g., in FIG. 1 is a fishing fly) for positional securement to allow for hands free holding of the fishing fly 25 while the user inserts the free end of the fishing line 30 through an eyelet on the fishing fly 25 and then tying the desire knot. Such configuration of the semi-rigid flexible extension arm 20 permits the user (e.g., a fisherman) to moveably and flexibly position the flexible extension arm 20 into an ideal useable and easily viewable position in front of the user.

The first member section 15 and second member section 10 when made in a rigid form can be made from any desirable material that provides a sufficiently non-flexible characteristic such that the first member section 15 and second member section 10 retain rigidity during use. In contrast, the first member section 15 and second member section 10 when made in a semi-rigid flexible form have a generally flexible characteristic such they can be manipulated and adjusted by the user by hand and are made from any desirable material that provides a sufficiently semi-rigid yet flexible characteristic such that the first member section 15 retains is rigidity during use. One skilled in the art will readily recognize that such rigid and semi-rigid first member section 15 and second member section 10 can be made from any desirable material that provides the desired rigidity or semi-rigid flexibility. Examples of a rigid material may be any form of metal, plastic, or combination of metal and plastic that provides such desired rigidity. Examples of a semi-rigid flexible material may be any form of flexible metal or plastic or flexible material that can be manipulated by the user such that a desired shape and position of each first member section 15, second member section 10 and flexible extension arm 20 can attained.

In FIGS. 1-3 the device 1 is configured such that the first member section 15 and the second member section 10 are connected in a removable, adjustable and pivotable configuration. Such configuration and connection provide for a stable device 1 to rest generally against the chest of a user (e.g., a fisherman, seamstress, hobbyist, artist, etc.) while also permitting the user to adjust the position of each of the first member section 15 and the second member section 10 for optimum balance and position for attachment to the user's body and/or clothing. Additionally, the device 1, can be either disconnected or folded at the connection point of the first member section 15 and the second member section 20 when not in use or when the device 1 is to be stored away.

As can be seen in FIGS. 1-3, the device 1 further comprises positional and moveable attachment straps 2 or other attachment mechanism that aide in the stable securement of the device 1 to the user's chest, clothing, or the like. Such securement ensures that the device 1 does not move around and generally remain in one relative position about the user's body or become entangled with other items that the user may be working with while the device 1 is in use. In the present disclosure such attachment straps 2 can be flexible ties, straps, hook and loop style fasteners, straps with snaps, straps with buttons, buttons, or any other securement mechanism.

Further reference to FIGS. 1-3, it is shown that semi-rigid, but flexible extension arm 20 is configured in a movable attachment to the first member section 15. As can be clearly seen in reference to FIG. 1, the work tool 5, when using a clamp, provides the device 1 with the ability to grasp any object (e.g., a fishing lure or fishing fly 25) in a fixed, free position in front of the user. Specifically, the clamp is able to grasp and steadily and securely hold the workpiece 25 such as for example a fishing lure or fishing fly to aid the user with insertion of fishing line 30, or the like, into the fishing fly 25.

In specific reference to FIG. 2, an alternate embodiment is shown wherein the device 1 is comprised of all semi-rigid flexible components such as the first member section 15, the second member section 10, and the flexible extension arm 20. Such full device 1 flexibility allows the user to adapt each of the first member section 15, the second member section 10, and the flexible extension arm(s) 20 of the device 1 to accommodate the user's specific desires for positional ease of attachment to the user's clothing by use of positional and moveable attachment straps 2. Thus, the device 1 is removably secured to the body or clothing of the user, for example a fisherman thus keeping the device 1 in a relative stable and fixed position relative to the fisherman's body. When a flexible extension arm 20 comprises a clamp such use permits easy positioning and holding of a fishing fly 25 to ensure stability of the fishing fly 25 and ensure it is near the front chest area of the fisherman to permit ease of viewing an eyelet 29 of the fishing fly 25 for insertion of the fishing line 30.

As mentioned, the device 1 may also comprise a removable magnification device (not shown) that is attachable on the distal end 18 of the flexible extension arm 20. Because of the flexibility of the flexible extension arm 20, the workpiece 25 (e.g., the fishing fly) can be ideally positioned to enable the fisherman to best see and install the fishing line 30 through the eyelet 29 of the fishing fly without having to physically hand hold the fishing fly in one hand and the fishing line 30 in the other, while also managing other equipment such as a fishing pole that is part of the required ensemble.

One skilled in the art will recognize that the type of materials disclosed herein from which the present embodiment of the device 1 is constructed are not meant to be limiting and that other suitable materials can be used without departing from the spirit of the invention.

Embodiments of the device 1 as provided and disclosed above may configured in any desired overall dimensions or in specifics so as to accommodate the specific device 1 desired for use. However, other embodiments contemplated by the inventors can have any dimension that also accomplishes a specific desired function. Although the disclosed embodiments are not illustrated as having certain general, absolute, and relative dimensions, those having skill in the art will recognize that any approximate or absolute and relative dimensions can be utilized in accordance with varying design considerations. Other embodiments that do not have the same approximate or absolute and relative dimensions can be envisioned without departing from the scope of the invention and claims. Moreover, the disclosed embodiments are not necessarily illustrated to scale or in any particular use position.

Without further elaboration, it is believed that one skilled in the art can, using the description herein, utilize the present disclosure to its fullest extent. The foregoing outlines features of several embodiments so that those skilled in the art may better understand the aspects of the disclosure. Those skilled in the art should appreciate that they may readily use the disclosure as a basis for designing or modifying other processes and structures for carrying out the same purposes and/or achieving the same advantages of the embodiments introduced herein. Those skilled in the art should also realize that such equivalent constructions do not depart from the spirit and scope of the disclosure, and that they may make various changes, substitutions, and alterations herein without departing from the spirit and scope of the disclosure. The scope of the invention should be determined only by the language of the claims that follow. The term “comprising” within the claims is intended to mean “including at least” such that the recited listing of elements in a claim are an open group. The terms “a,” “an” and other singular terms are intended to include the plural forms thereof unless specifically excluded.

What is claimed is:

1. An apparatus for temporarily holding small objects for adjustment or manipulation, apparatus comprising:
a first member section;
a second member section removably and pivotably attached to the first member section; and,
at least one flexible extension arm removably and adjustably attached to at least the first member section, wherein the at least one flexible extension arm comprises a work tool removably attached to a distal end of the at least one flexible extension arm.

2. The apparatus of claim 1, wherein the first member section and the second member section are made of a rigid material.

3. The apparatus of claim 1, wherein the first member section and the second member section are made of a semi-rigid flexible material.

4. The apparatus of claim 1, wherein the first member section and the second member section are removably connected.

5. The apparatus of claim 1, wherein the first member section and the second member section are hingeably connected.

6. The apparatus of claim 1, wherein the first member section and the second member section are removably and hingeably connected.

7. The apparatus of claim 1, wherein there are two or more flexible extension arms.

8. The apparatus of claim 1, wherein the at least one flexible extension arm comprises a removably attached work tool at the distal end of the flexible extension arm.

9. The apparatus of claim 7, wherein the removably attached work tool is a clamp.

10. The apparatus of claim 7, wherein the two or more flexible extension arms comprise at least one removeably attached work tool selected from the group consisting of a clamp, a miniature light, a mirror, a magnifying glass, a scissors, a knife.

11. An apparatus for temporarily holding small objects for adjustment or manipulation, apparatus comprising:
a semi-rigid flexible first member section;
a semi-rigid flexible second member section removably and pivotably attached to the first member section; and,
at least one flexible extension arm removably and adjustably attached to at least the first member section, wherein the at least one flexible extension arm comprises a work tool removably attached to a distal end of the at least one flexible extension arm.

12. The apparatus of claim 11, wherein the first member section and the second member section are removably connected.

13. The apparatus of claim 11, wherein the first member section and the second member section are hingeably connected.

14. The apparatus of claim 11, wherein the first member section and the second member section are removably and hingeably connected.

15. The apparatus of claim 11, wherein there are two or more flexible extension arms.

16. The apparatus of claim 11, wherein the at least one flexible extension arm comprises a removably attached work tool at the distal end of the flexible extension arm.

17. The apparatus of claim 15, wherein the removably attached work tool is a clamp.

18. The apparatus of claim 15, wherein the two or more flexible extension arms comprise at least one removeably attached work tool selected from the group consisting of a clamp, a miniature light, a mirror, a magnifying glass, a scissors, a knife.

19. An apparatus for temporarily holding small objects for adjustment or manipulation, apparatus comprising:
a semi-rigid flexible first member section;
a rigid second member section removably and pivotably attached to the first member section;
and,
at least one flexible extension arm removably and adjustably attached to at least the first member section, wherein the at least one flexible extension arm comprises a work tool removably attached to a distal end of the at least one flexible extension arm.

20. The apparatus of claim 19, wherein two or more of the at least one flexible extension arms comprise at least one removeably attached work tool selected from the group consisting of a clamp, a miniature light, a mirror, a magnifying glass, a scissors, a knife.
